(19) United States
(12) Patent Application Publication
(10) Pub. No.: US 2010/0146538 A1
(43) Pub. Date: Jun. 10, 2010

(54) METHOD AND APPARATUS FOR TRANSMITTING/RECEIVING BROADCASTING PROGRAM ID

(75) Inventors: Won-Sik CHEONG, Daejon (KR); Jeho NAM, Seoul (KR); Jooyoung LEE, Seoul (KR); Sangwoo AHN, Daejon (KR); Sang-Kwon SHIN, Daejon (KR); Moon-Kyun OH, Daejon (KR); Hyon-Gon CHOO, Daejon (KR); Jin-Woo HONG, Daejon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejon (KR)

(21) Appl. No.: 12/632,871

(22) Filed: Dec. 8, 2009

(30) Foreign Application Priority Data
Dec. 9, 2008 (KR) 10-2008-0124583
May 19, 2009 (KR) 10-2009-0043585

(51) Int. Cl. H04N 7/167; H04N 7/025

(52) U.S. Cl. 725/31; 380/202; 725/32

(57) ABSTRACT

Provided is a method and apparatus for transmitting/receiving broadcasting program ID for identifying a broadcasting program along with a broadcasting program. The method for transmitting a broadcasting program, includes: acquiring audio/video bitstream for at least one broadcasting program; acquiring a broadcasting program identification (ID) corresponding to the broadcasting program; generating a media file including the audio/video bitstream and metadata; and transmitting the media file, wherein the metadata includes the broadcasting program ID and reference information for the audio/video bitstream.

### CROSS-REFERENCES TO RELATED APPLICATIONS

The present invention claims priority of Korean Patent Application Nos. 10-2008-0124583 and 10-2009-0043585, filed on Dec. 9, 2008, and May 19, 2009, respectively, which are incorporated herein by reference in their entirety.

### BACKGROUND OF THE INVENTION

1. Field of the Invention

The present invention relates to a method and apparatus for transmitting/receiving broadcasting program identification (ID); and, more particularly, to a method and apparatus for transmitting/receiving broadcasting program ID for identifying a broadcasting program along with a broadcasting program.

2. Description of Related Art

Along with recent advancement in communication technology, a broadcasting program distribution service is drawing attention from the public and industry. Broadcasting programs are distributed in diverse forms. Among them are a form of providing a re-run service for broadcasting programs, a form of a broadcasting service provider running a broadcasting program distribution server to sell broadcasting programs through the Internet, and so forth. These broadcasting program distribution services are now provided on the market. As for a broadcasting program distribution service discussed to be realized in the near future is a service of ‘previewing’ part of a broadcasting program to a viewer and if the viewer wants to keep on watching the broadcasting program, providing a ‘re-run’ or ‘download’ service for the broadcasting program. Also discussed as an effort for promoting the distribution of broadcasting programs is sharing distribution benefits between a copyright holder and viewers, such as, a method of a viewer who are watching a broadcasting program recording a broadcasting program and distributing the recorded broadcasting program.

The high-quality terrestrial broadcasting services commercialized at present are provided to viewers for free of charge. However, the number of cases distributing broadcasting programs without any protection for copyright through a web hard service or a personal computer-to-personal computer (P2P) service is known to be increasing. In particular, terrestrial broadcasting programs broadcasted in digital technology are being distributed through the Internet as soon as they are shown. In order to resolve this problem, researchers are studying in diverse ways to develop broadcasting program protection technology that can prevent the illegal copying and distribution of broadcasting programs and protect the copyright.

To prevent illegal distribution of broadcasting programs, it is as important to make viewers attain and watch broadcasting programs in a legal way as to protect the broadcasting programs from illegal use. In this regard, the distribution of broadcasting programs through a communication network should be stimulated and it is required to equip each broadcasting program with a broadcasting program identification (ID) that is unique to the broadcasting program for the distribution of the broadcasting program.

### SUMMARY OF THE INVENTION

An embodiment of the present invention is directed to providing a method and apparatus for transmitting/receiving a broadcasting program identification (ID), the method and apparatus which can identify a broadcasting program, facilitate the management of broadcasting programs, and stimulate distribution of the broadcasting programs.

Another embodiment of the present invention is directed to providing a method and apparatus for transmitting/receiving a broadcasting program ID, the method and apparatus which can easily acquire and use the ID of a broadcasting program without analyzing the broadcasting program itself included in a file in the form of audio/video stream.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a method for transmitting a broadcasting program, which includes: acquiring audio/video bitstream for at least one broadcasting program; acquiring a broadcasting program identification (ID) corresponding to the broadcasting program; generating a media file including the audio/video bitstream and metadata; and transmitting the media file, wherein the metadata includes the broadcasting program ID and reference information for the audio/video bitstream.

In accordance with another aspect of the present invention, there is provided a method for receiving a broadcasting program, which includes: receiving a media file including audio/video bitstream and metadata for at least one broadcasting program; acquiring the metadata by analyzing the media file; and acquiring broadcasting program ID for the broadcasting program out of the metadata, wherein the metadata includes reference information for the audio/video bitstream.

In accordance with another aspect of the present invention, there is provided an apparatus for transmitting a broadcasting program, which includes: a bitstream manager configured to acquire audio/video bitstream for at least one broadcasting program; an ID manager configured to acquire a broadcasting program ID corresponding to the broadcasting program; a media file generator configured to generate a media file including the audio/video bitstream and metadata; and a transmitter configured to transmit the media file, wherein the metadata includes the broadcasting program ID and reference information for the audio/video bitstream.

In accordance with another aspect of the present invention, there is provided an apparatus for receiving a broadcasting program, which includes: a receiver configured to receive a media file including audio/video bitstream and metadata for at least one broadcasting program; a media file analyzer configured to acquire the metadata by analyzing the media file; and an ID manager configured to acquire a broadcasting program ID for the broadcasting program out of the metadata, wherein the metadata includes reference information for the audio/video bitstream.

### BRIEF DESCRIPTION OF THE DRAWINGS

FIG. 1 shows a broadcasting program distribution service network to which a broadcasting program transmitting and receiving method of the present invention is applied.

FIG. 2 is a block view illustrating a broadcasting program transmitting apparatus in accordance with an embodiment of the present invention.

FIG. 3 is a block view illustrating a broadcasting program receiving apparatus in accordance with an embodiment of the present invention.

FIG. 4 is a flowchart describing a process of transmitting broadcasting program identification (ID) information in accordance with an embodiment of the present invention.

FIG. 5 is a flowchart describing a process of receiving broadcasting program ID information in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. While describing the present invention, when it is considered that detailed description on a prior art may obscure a point of the present invention, the description will not be provided herein. Hereafter, exemplary embodiments of the present invention will be described in detail with reference to the accompanying drawings. The same reference numerals are given to the same constituent elements.

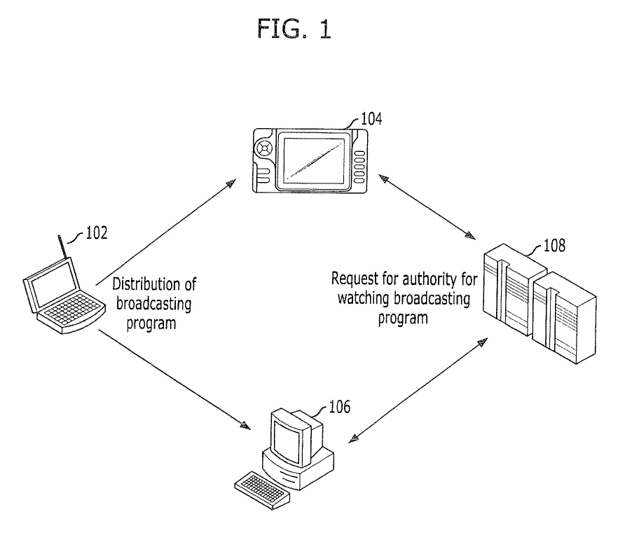

FIG. 1 shows a broadcasting program distribution service network to which a broadcasting program transmitting and receiving method of the present invention is applied. Referring to FIG. 1, the broadcasting program distribution service network includes a broadcasting program transmitter 102 for distributing broadcasting programs, broadcasting program receivers 104 and 106 for receiving and showing the broadcasting programs from the broadcasting program transmitter 102, and a broadcasting program management server 108 for managing an authority for watching the distributed broadcasting programs.

The broadcasting program transmitter 102 distributes broadcasting programs broadcasted through a terrestrial television (TV) or cable TV. The broadcasting program transmitter 102 may be a typical broadcasting service provider or it may be a viewer who is watching a broadcasting program. First, the broadcasting service provider may provide a re-run service for a broadcasting program which was broadcasted before. The re-run service may be provided through a distribution network such as a broadcasting service network and the Internet. Examples of the broadcasting service network and the Internet includes a cable broadcasting service network, a satellite broadcasting service network, a mobile broadcasting service network, a Video on Demand (VOD) service, Internet Protocol TV (IPTV) service network, and so forth.

Recently, there is a service of sharing the profits and benefits induced from the distribution of broadcasting programs between the copyright holders and viewers by allowing the viewers to record and distribute the broadcasting programs. This type of service is provided in an effort for stimulating the distribution of broadcasting programs. Therefore, when the broadcasting program transmitter 102 is a viewer, the broadcasting program transmitter 102 records and stores a target broadcasting program with a broadcasting receiver having a recording/storing function and distributes the broadcasting program through the Internet or by using a storage medium.

The broadcasting program transmitter 102 distributes broadcasting programs through a broadcasting network or the Internet. To prevent the broadcasting program from being illegally distributed, the broadcasting programs should be distributed in an encrypted form. The broadcasting program receivers 104 and 106 receiving a broadcasting program should acquire an authority for watching the broadcasting program. After acquiring the watching authority, the broadcasting program receivers 104 and 106 go through a decryption process and watch the broadcasting program. As illustrated in FIG. 1, the broadcasting program receivers 104 and 106 may receive and watch the broadcasting program by using a Portable Multimedia Player (PMP) 104, a personal computer 106, and other types of terminals.

The broadcasting program management server 108 receives a request for watching authority from the broadcasting program receivers 104 and 106 and issues the watching authority to the broadcasting program receivers 104 and 106. The broadcasting program receivers 104 and 106 receive a broadcasting program, access the broadcasting program management server 108, and make a request for watching authority for the broadcasting program. The broadcasting program management server 108 performs an authentication process and a charging process for the broadcasting program receivers 104 and 106 and then issues the watching authority for the broadcasting program to the broadcasting program receivers 104 and 106.

In order to provide the broadcasting program distribution service described with reference to FIG. 1, a target broadcasting program to be distributed should be identified and managed. In order to have a broadcasting program be identified, the following particulars should be specifically defined in broadcasting program identification (ID).
broadcasting service provider of the broadcasting program
program code assigned by the broadcasting service provider to the broadcasting program
valid term of the program code assigned to the broadcasting program

Researchers are discussing to standardize the broadcasting program ID out of the necessity for the broadcasting program ID and for providing a broadcasting program distribution service. Among the specifications for broadcasting program ID is Advanced Television Systems Committee (ATSC) A/57, which suggests a method for uniquely identifying contents, including broadcasting programs. The ATSC A/57 has put out Revision B in May 2008. The structure of ATSC_content_identifier defined in the ATSC A/57B is shown in the following Table 1.

TABLE 1

| | No. of | |
|---|---|---|
| Syntax | Bits | Format |
| ATSC_content_identifier( ) { | | |
| TSID | 16 | uimsbf |
| reserved | 2 | bslbf |
| end_of_day | 5 | uimsbf |
| unique_for | 9 | uimsbf |
| content_id | var | |
| } | | |

The meaning of each field appearing in the Table 1 is as follows.
TSID: having a value of transport stream id defined in ATSC A/65 (which is Program and System Information Protocol (PSIP) specification)
end_of_day: a field representing an end of a day based on Universal Time Coordinated (UTC) and indicating time from 0 to 23. When a valid date is determined based on ‘house number’ defined in the below unique_for field, the end of the corresponding date is represented not by a physical date but by the time defined in the end_of_day.
unique_for: term during which content_id should be uniquely managed. In short, the term when the content_id should not be re-used. The unit of unique_for is ‘day.’ It is prohibited to use ‘0 ’ and ‘511’ represents ‘infinitely.’
content_id: a field representing ID. The length of content_id should not be longer than 242 bytes.

Meanwhile, Korean standardization is underway for a technology of adding a broadcasting program ID to terrestrial digital TV (DTV) broadcasting signals. According to the Korean standardization, the broadcasting program ID is scheduled to be included in the content_id of the ATSC_content_identifier shown in the Table 1. The content_id defined in the Korean Standard specification, which is being discussed, is shown in the following Table 2.

TABLE 2

| Syntax | Bits | |
|---|---|---|
| content_id( ) { | | |
| major_channel_number | 10 | Transmission |
| | | channel |
| minor_channel_number | 10 | |
| reserved | 4 | |
| onair_time | 32 | Transmission time |
| reserved | 1 | |
| length_of_program_code | 7 | Program code length |
| program_code | var | Program's own code |
| } | | |

The meaning of each field appearing in the Table 2 is as follows.
major_channel_number, minor_channel_number: virtual channel through which a broadcasting program is transmitted. Channel information inside a broadcasting program ID should coincide with channel information inside PSIP.
onair_time: time when the broadcasting program begins to be broadcasted.
length_of_program_code: length of program_code
program_code: broadcasting program's own code managed by each broadcasting station.

As shown in the Tables 1 and 2, the content_id includes a program's own code (program_code) which is being used by each broadcasting station. The content_id is again included in the ATSC_content_identifier. The ATSC_content_identifier is added to content_labeling_descriptor defined in the Moving Picture Experts Group 2 (MPEG-2) Systems (ISO/IEC 13818-1:2007) Specification.

The Korean Standard plan which is being discussed refers to the content_id as ‘broadcasting program ID.’ On the other hand, the term used to describe the present invention, which is broadcasting program ID, is not only ID information for uniquely identifying a broadcasting program but also a term of a concept including ATSC_content_identifier defined in the ATSC specification as well as the content_id defined in the Korean Standard specification.

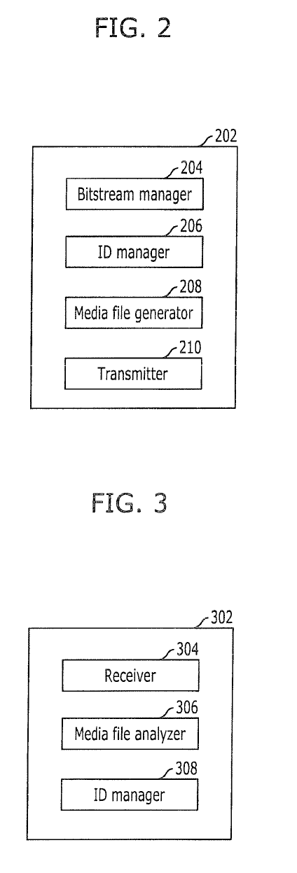

The ATSC Standard specification and the Korean Standard specification described with reference to FIGS. 1 and 2 are standards for specifications of adding the broadcasting program ID to MPEG-2 transport stream (TS) and transmitting the MPEG-2 transport stream with the broadcasting program ID. These standards do not define a specification for storing a broadcasting program.

Meanwhile, among the standards for storing a broadcasting program in the form of a file is ISO Base Media File Format. According to the ISO Base Media File Format, a broadcasting program may be stored in the form of MPEG-2 transport stream, and system information, such as Program Association Table (PAT) or Program Map Table (PMT), along with the MPEG-2 transport stream. However, the ISO Base Media File Format does not define a method for effectively storing a broadcasting program ID.

After all, in order to support an application service that stores and re-uses a broadcasting program, such as the broadcasting program distribution service shown with reference to FIG. 1, the broadcasting program ID should be stored separately from audio/video stream like MPEG-2 transport stream. In this way, it is possible to identify a broadcasting program without directly analyzing the audio/video stream.

Accordingly, an embodiment of the present invention provides a method of effectively storing a broadcasting program ID that can identify a broadcasting program in the broadcasting program distribution service where a broadcasting program is stored in the form of an electronic file and delivered to a viewer. With this method, a broadcasting program ID may be easily extracted and used without directly analyzing the broadcasting program itself included in the file in the form of MPEG-2 transport stream.

FIG. 2 is a block view illustrating a broadcasting program transmitting apparatus 202 in accordance with an embodiment of the present invention. Referring to FIG. 2, the broadcasting program transmitting apparatus 202 includes a bitstream manager 204, an ID manager 206, a media file generator 208, and a transmitter 210.

The bitstream manager 204 acquires audio/video bitstream for at least one broadcasting program. The audio/video bitstream may have a form of MPEG stream, such as MPEG-2 transport stream. Also, the broadcasting program may be provided directly by a broadcasting station providing a broadcasting service or one recorded or stored by a viewer with a device. The bitstream manager 204 may encrypt the acquired audio/video stream.

The ID manager 206 acquires a broadcasting program ID for the broadcasting program. The broadcasting program ID uniquely identifies the broadcasting program and it may be stored in diverse forms such as binary number and text. The broadcasting program ID may include valid term information of the broadcasting program ID, virtual channel information through which the broadcasting program is transmitted, broadcasting time information of the broadcasting program, broadcasting program code information of the broadcasting program and the like.

The media file generator 208 generates a media file including the audio/video bitstream acquired in the bitstream manager 204 and metadata. The media file may be generated based on the ISO Base Media File Format. Also, the metadata includes the broadcasting program ID and reference information on the audio/video bitstream. Since metadata includes a broadcasting program ID, the broadcasting program ID is stored and managed separately from the audio/video bitstream.

The transmitter 210 transmits the media file generated in the media file generator 208.

FIG. 3 is a block view illustrating a broadcasting program receiving apparatus 302 in accordance with an embodiment of the present invention. The broadcasting program receiving apparatus 302 includes a receiver 304, a media file analyzer 306, and an ID manager 308.

The receiver 304 receives a media file including audio/video bitstream and metadata for at least one broadcasting program. The media file may be generated based on the ISO Base Media File Format.

The media file analyzer 306 analyzes the media file received by the receiver 304 and acquires metadata. The metadata includes reference information on the audio/video bitstream.

The ID manager 308 acquires a broadcasting program ID included in the acquired metadata. The broadcasting program ID may include valid term information of the broadcasting program, virtual channel information through which the broadcasting program is broadcasted, transmission time information of the broadcasting program, broadcasting program code information of the broadcasting program and the like. Also, the ID manager 308 acquires a viewing authority for the broadcasting program based on the acquired broadcasting program ID.

Hereafter, a method of storing a broadcasting program ID in accordance with an embodiment of the present invention will be described based on what has been described in the above.

According to conventional technology, since MPEG-2 transport stream for a broadcasting program includes a broadcasting program ID, a file storing the MPEG-2 transport stream also includes the broadcasting program ID as well. However, when the broadcasting program ID is contained in the MPEG-2 transport stream, there is a problem in hat the MPEG-2 transport stream should be parsed to be extracted whenever the broadcasting program ID is needed. Particularly, when the MPEG-2 transport stream is stored in an encrypted form for copyright protection, a decryption process should be additional performed to extract the broadcasting program ID and this may cause another problem in the aspect of the protection of the broadcasting program. To resolve this problem, the broadcasting program should be stored in such a manner that the broadcasting program ID could be acquired easily.

Therefore, it is desirable to separately store and manage the broadcasting program ID in metadata related to MPEG-2 transport stream, rather than to have it exist in the MPEG-2 transport stream. Also, the broadcasting program ID includes program_code varying according to a broadcasting program. Therefore, when the MPEG-2 transport stream stored in one file includes MPEG-2 transport streams of a plurality of broadcasting programs, the broadcasting program IDs corresponding to the respective broadcasting programs should be stored as well.

The requirements related to the storing of a broadcasting program ID may be listed as follows.

1) Broadcasting program ID and information included in the broadcasting program ID should be managed separately so that the broadcasting program ID could be easily extracted out of a file.

2) To which part of MPEG-2 transport stream of a file the broadcasting program ID is related could be detected easily.

As for a storing method that can satisfy the above two requirements, there is a method of defining a box and storing a broadcasting program ID in a sample entry of a precomputed hint track of MPEG-2 transport stream. Hereafter, a method for storing a broadcasting program ID by using a precomputed hint track in accordance with an embodiment of the present invention will be described.

The ISO Base Media File Format is a specification for a storing type of MPEG-2 transport stream. A first storing method among the storing methods mentioned in the ISO Base Media File Format is to store media stream, which is audio/video bitstream, constituting MPEG-2 transport stream in a separate media track and store data needed to generate MPEG-2 transport stream, such as a transport stream header and an adaptation field, in a hint track. In this case, the hint track only refers to the media tack.

A second storing method is to store MPEG-2 transport stream in the hint track as it is. This method is called ‘precomputed hint track.’ The precomputed hint track method allows the MPEG-2 transport stream stored as a separate file to be usable and provides a simple recording function. In particular, when the MPEG-2 transport stream is encrypted for the protection of the broadcasting program, a precomputed hint track is used because it is impossible to separate media stream out of the MPEG-2 transport stream. When a broadcasting program is distributed, the broadcasting program is usually stored in an encrypted form in order to allow only a user or a device given with a watching authority for the broadcasting program to watch or reproduce the broadcasting program. Therefore, it is general to store MPEG-2 transport stream in a precomputed hint track.

The precomputed hint track is part of the ISO/IEC 14496-12 Specification, which is an open standard, and the precomputed hint track is already widely known to those of ordinary skill in the art to which the present invention pertains. For this reason, the precomputed hint track will be briefly explained in this specification to help understand the technological concept and scope of the present invention and detailed description on it will not be provided herein.

A sample format of a precomputed hint track includes MPEG-2 transport stream packets which include ‘precedingbytes’ and ‘trailingbytes,’ and the sample format of a precomputed hint track is as shown in the following Table 3.

TABLE 3

```
aligned(8) class MPEG2TSSample {
    uint(8)  precedingbytes[precedingbyteslen];
    uint(8)  packet[188];
}
```

Meanwhile, the sample description format of the precomputed hint track allows all static metadata describing stream or some static metadata including PSI/SI table to be stored. The following Table 4 shows a sample entry of MPEG-2 transport stream (MPEG2TSSampleEntry) based on what is defined in the sample description format.

```
TABLE 4
class MPEG2TSSampleEntry(name) extends HintSampleEntry(name) {
    uint(16)  hinttrackversion = 1;
    uint(16)  highestcompatibleversion = 1;
    uint(8)  precedingbyteslen;
    uint(8)  trailingbyteslen;
    uint(1)  precomputed_only_flag;
    uint(7)  reserved;
    box  additionaldata[ ];
}
```

As shown in the Table 4, the sample entry is formed for the purpose of storing metadata describing the features of stored streams. Current ISO Base Media File Format defines boxes (such as ‘tPAT’ and ‘tPMT’) for facilitating the extraction of system information for MPEG-2 transport stream by separately storing and managing system informations for stored MPEG-2 transport stream. These boxes may be positioned in an ‘additionaldata’ field of the sample entry shown in the Table 4. Therefore, if a new box that may be positioned in the ‘additionaldata’ field and the broadcasting program ID is stored in the new box, the first one of the aforementioned requirements related to the storing of broadcasting program ID can be satisfied.

Meanwhile, when one MPEG-2 transport stream includes several broadcasting programs, it needs to store broadcasting program IDs corresponding to the respective broadcasting programs. The ISO/IEC 14496-12 defines to add a new sample entry whenever there is a change in the stored metadata. Thus, it is possible to add a new sample entry when there is a change in the broadcasting program ID. A new chunk is stored in the position of MPEG-2 transport stream corresponding to a new sample entry. A sample entry related to a new chunk is specified in ‘sample_description_index’ of a sample-to-chunk blox. Therefore, when several broadcasting programs are stored in one MPEG-2 transport stream, it is easy to recognize which part of MPEG-2 transport stream a broadcasting program ID is related to. Accordingly, the second one of the requirement related to the storing of broadcasting program ID can be satisfied.

Based on the above, it is possible to form the ATSC_content_identifier and the content_ID, which have been mentioned in the above in a box included in the sample array. The following Tables 5 and 6 are ATSC_content_identifier and content_id represented as boxes, respectively.

TABLE 5

| class ATSCContentIdentifierBox extends Box(‘acid’) { | |
|---|---|
| unsigned int(16) | TSID; |
| const bit(5) | reserved = 0; |
| unsigned int(5) | end_of_day; |
| unsinged int(9) | unique_for; |
| box | content_id_box; |
| } | |

TABLE 6
class ProgramIdentifierBox extends Box(‘prid’) {

| | |
|---|---|
| unsigned int(10) | major_channel_number; |
| unsigned int(10) | minor_channel_number; |
| const bit(4) | reserved = 0; |
| unsigned int(32) | onair_time; |
| const bit(1) | reserved = 0; |
| unsinged int(7) | length_of_program_code; |
| unsigned int(8) | program_code[length_of_program_code]; |
| } | |

The box structures shown in the Tables 5 and 6 include the fields shown in the ATSC_content_identifier and the content_id shown in the Tables 1 and 2 as they are. Therefore, the meanings of the fields are the same as described in the Table 1 and 2. Meanwhile, ‘content_id_box’ shown in the Table 5 includes ‘prid,’ which is a box for the content_id defined in the Table 6.

Other than the method of storing a broadcasting program ID by using a box of a sample entry, a broadcasting program ID may be stored through diverse methods, such as a method of storing a broadcasting program ID in a ‘meta’ box as eXclusive Markup Language (XML) or binary numbers or a method of storing a broadcasting program ID as binary numbers in a sample entry.

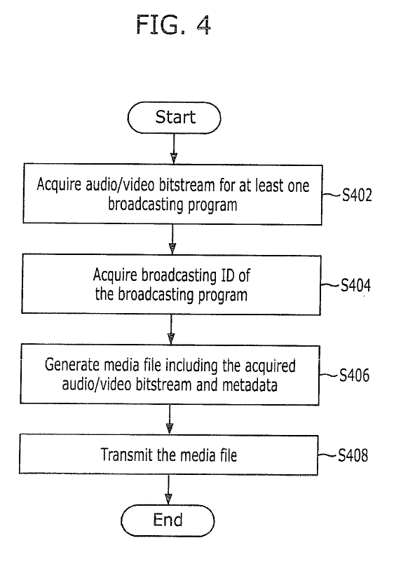

FIG. 4 is a flowchart describing a process of transmitting broadcasting program identification (ID) information in accordance with an embodiment of the present invention.

In step S402, audio/video bitstream is acquired for at least one broadcasting program. The audio/video bitstream may have an MPEG stream form such as MPEG-2 transport stream. Also, the broadcasting program may be directly provided by a broadcasting station providing a broadcasting service or it may be recorded or stored directly by a viewer with a device.

In step S404, broadcasting program ID corresponding to the broadcasting program is acquired. The broadcasting program ID is for identifying a corresponding broadcasting program and it may be stored in diverse types such as binary numbers or text. The broadcasting program ID includes valid term information of the broadcasting program ID, virtual channel information through which the broadcasting program is transmitted, transmission time information of the broadcasting program, broadcasting program code information for the broadcasting program and the like.

In step S406, a media file including the acquired audio/video bitstream and metadata is generated. Herein, the media file may be generated based on the ISO Base Media File Format. Also, the metadata includes broadcasting program ID and reference information for audio/video bitstream. Since the metadata includes the broadcasting program ID, the broadcasting program ID is stored and managed separately from the audio/video bitstream after all. Finally, in step S408, the generated media file is transmitted.

Meanwhile, although not illustrated in FIG. 4, an encryption process for encrypting the audio/video bitstream may be performed before or when the media file is generated. The encryption process is performed to allow only receivers with a watching authority to watch the broadcasting program. Although the encryption process is performed, since the broadcasting program ID is included in the metadata separately from the audio/video bitstream, the receivers can easily acquire the broadcasting program ID regardless of whether the audio/video bitstream is encrypted or not.

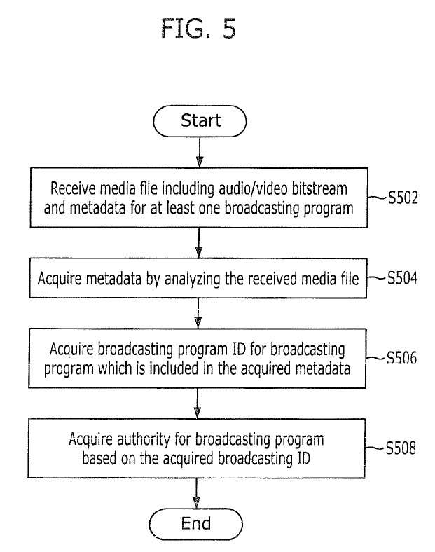

FIG. 5 is a flowchart describing a process of receiving broadcasting program ID information in accordance with an embodiment of the present invention.

First, in step S502, a media file including audio/video bitstream and metadata for at least one broadcasting program is received. The media file may be generated based on the ISO Base Media File Format.

In step S504, the received media file is analyzed and metadata are acquired. Herein, the metadata may include reference information for the audio/video bitstream.

After the metadata are acquired, in step S506, broadcasting program ID included in the metadata is acquired. The broadcasting program ID may include valid term information of the broadcasting program ID, virtual channel information through which the broadcasting program is transmitted, transmission time information of the broadcasting program, broadcasting program code information for the broadcasting program.

Finally, in step S508, a watching authority for the broadcasting program is acquired based on the acquired broadcasting program ID. When the watching authority is acquired, an authentication process or a charging process may be performed. When the audio/video bitstream are transmitted after encrypted, a process of decrypting the encrypted audio/video bitstream by using the acquired broadcasting program ID or the watching authority may be performed additionally.

The technology of the present invention described above has an advantage in that it can easily identify and manage a broadcasting program and stimulate distribution of broadcasting programs by transmitting/receiving broadcasting program ID along with the broadcasting program.

Also, with the technology of the present invention, it is possible to easily acquire and use the broadcasting program ID of a broadcasting program without analyzing the broadcasting program included in audio/video bitstream.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media, that is, it includes not only tangible media such as CD and DVD, but also intangible media such as carrier wave.

While the present invention has been described with respect to the specific embodiments, it will be apparent to those skilled in the art that various changes and modifications may be made without departing from the spirit and scope of the invention as defined in the following claims.

What is claimed is:

1. A method for transmitting a broadcasting program, comprising:
acquiring audio/video bitstream for at least one broadcasting program;
acquiring a broadcasting program identification (ID) corresponding to the broadcasting program;
generating a media file including the audio/video bitstream and metadata; and
transmitting the media file,
wherein the metadata includes the broadcasting program ID and reference information for the audio/video bitstream.

2. The transmission method of claim 1, wherein the broadcasting program ID includes at least one selected from the group consisting of valid term information of the broadcasting program ID, virtual channel information through which the broadcasting program is transmitted, transmission time information of the broadcasting program, and broadcasting program code information for the broadcasting program.

3. The transmission method of claim 1, wherein the media file is generated based on International Organization for Standardization (ISO) Base Media File Format, and the audio/video bitstream and metadata included in the media file are generated in a form of a Moving Picture Experts Group (MPEG) stream.

4. The transmission method of claim 2, wherein the metadata are formed in a sample entry form of MPEG-2 transport stream, and the broadcasting program ID is formed in a box form of the sample entry.

5. The transmission method of claim 1, wherein the broadcasting program ID is stored in a form of binary numbers or text.

6. The transmission method of claim 1, further comprising:
encrypting the audio/video bitstream.

7. A method for receiving a broadcasting program, comprising:
receiving a media file including audio/video bitstream and metadata for at least one broadcasting program;
acquiring the metadata by analyzing the media file; and
acquiring broadcasting program identification (ID) for the broadcasting program out of the metadata,
wherein the metadata includes reference information for the audio/video bitstream.

8. The reception method of claim 7, wherein the broadcasting program ID includes at least one selected from the group consisting of valid term information of the broadcasting program ID, virtual channel information through which the broadcasting program is transmitted, transmission time information of the broadcasting program, and broadcasting program code information for the broadcasting program.

9. The reception method of claim 7, further comprising:
acquiring a watching authority for the broadcasting program by using the broadcasting program ID.

10. An apparatus for transmitting a broadcasting program, comprising:
a bitstream manager configured to acquire audio/video bitstream for at least one broadcasting program;
an identification (ID) manager configured to acquire a broadcasting program ID corresponding to the broadcasting program;
a media file generator configured to generate a media file including the audio/video bitstream and metadata; and
a transmitter configured to transmit the media file,
wherein the metadata includes the broadcasting program ID and reference information for the audio/video bitstream.

11. The transmission apparatus of claim 10, wherein the broadcasting program ID includes at least one selected from the group consisting of valid term information of the broadcasting program ID, virtual channel information through which the broadcasting program is transmitted, transmission time information of the broadcasting program, and broadcasting program code information for the broadcasting program.

12. The transmission apparatus of claim 10, wherein the media file is generated based on International Organization for Standardization (ISO) Base Media File Format, and the audio/video bitstream and metadata included in the media file are generated in a form of a Moving Picture Experts Group (MPEG) stream.

13. The transmission apparatus of claim 12, wherein the metadata are formed in a sample entry form of MPEG-2 transport stream, and the broadcasting program ID is formed in a box form of the sample entry.

14. The transmission apparatus of claim 10, wherein the broadcasting program ID is stored in a form of binary numbers or text.

15. The transmission apparatus of claim 10, wherein the bitstream manager encrypts the audio/video bitstream.

16. An apparatus for receiving a broadcasting program, comprising:
a receiver configured to receive a media file including audio/video bitstream and metadata for at least one broadcasting program;
a media file analyzer configured to acquire the metadata by analyzing the media file; and
an identification (ID) manager configured to acquire a broadcasting program ID for the broadcasting program out of the metadata,
wherein the metadata includes reference information for the audio/video bitstream.

17. The reception apparatus of claim 16, wherein the broadcasting program ID includes at least one selected from the group consisting of valid term information of the broadcasting program ID, virtual channel information through which the broadcasting program is transmitted, transmission time information of the broadcasting program, and broadcasting program code information for the broadcasting program.

18. The reception apparatus of claim 16, wherein the ID manager acquires a watching authority for the broadcasting program by using the broadcasting program ID.
